(19) United States
(12) Patent Application Publication
(10) Pub. No.: US 2006/0284986 A1
(43) Pub. Date: Dec. 21, 2006

(54) Wireless terminal for reducing distortion of moving picture screen

(75) Inventors: Sang-Jin Ahn, Gumi-si (KR); Yeong-Moo Ryu, Gumi-si (KR); Ji-Hwa Kim, Woobang Sincheonji Town (KR); Woo-Seok Jang, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/340,607

(22) Filed: Jan. 27, 2006

(30) Foreign Application Priority Data
Jun. 15, 2005 (KR) 2005-51647

(51) Int. Cl. H04N 5/225

(52) U.S. Cl. 348/211.99; 348/207.99

(57) ABSTRACT

A wireless terminal includes a camera for shooting an image when the wireless terminal is set to a camera mode, and outputting the shot image data in units of a frame. An image processor outputs video frames from the camera in a predetermined number per unit time, and generates and outputs a synchronization signal for the output video frames. A pulse generator generates a predetermined converted pulse to scale down a frame frequency of a vertical synchronization signal of the synchronization signal at a predetermined ratio. A converter generates and outputs a converted vertical synchronization signal where the frame frequency of the vertical synchronization signal is converted at a predetermined ratio. A controller adjusts the number of video frames input from the image processor in a predetermined number per unit time, and controls the adjusted frames to be displayed on a display unit.

### PRIORITY

This application claims priority under 35 U.S.C. §119(a) of Korean Patent Application entitled “Wireless Terminal For Reducing Distortion Of Moving Picture Screen” filed in the Korean Intellectual Property Office on Jun. 15, 2005 and assigned Serial No. 2005-51647, the entire disclosure of which is hereby incorporated by reference.

### BACKGROUND OF THE INVENTION

1. Field of the Invention

The present invention relates to a wireless terminal. More particularly, the present invention relates to a wireless terminal for reducing the distortion of a moving picture screen displayed on a display unit thereof.

2. Description of the Related Art

Recently, a wireless terminal has been provided with a camera and allowed to display an image signal input from the camera. Thus, the wireless terminal with the camera can shoot an image to display either a moving picture or a still picture based on frame processing, and transmit the shot image.

FIG. 1 is a block diagram showing a conventional wireless terminal.

A wireless terminal shown includes a camera 10, an image processor 20, a controller 30, and a display unit 40.

The camera 10 shoots an image and outputs image signal data of the shot image to the image processor 20 by a frame.

The image processor 20 processes the image signal output from the camera 10 by the frame, and outputs the frame image data to meet a characteristic and size of the display unit 40.

When outputting moving picture frames (for example, a moving picture consisting of 30 frames per second), the image processor 20 generates and outputs a synchronization signal for the moving picture frames.

The controller 30 reads the moving picture frames output from the image processor 20 according to the synchronization signal, and then stores the moving picture frames in a memory (not shown), or displays the moving picture frames through the display unit 40. The controller 30 reads the moving picture frames out of the image processor 20 whenever a vertical synchronization signal is input.

When the wireless terminal transmits the moving picture to another wireless terminal, the controller 30 converts the output moving picture from the image processor 20 that has a high frame rate (for example, 30 frames per second), into an ordinary moving picture having 15 frames per second, and transmits the converted moving picture. The moving picture having 15 frames per second picture quality is not bad. Moreover, the moving picture having 15 frames per second has a reduced data capacity as compared with the moving picture having 30 frames per second.

Therefore, the controller 30 skips every other vertical synchronization signal output from the image processor 20 in order to convert the moving picture having a high frame rate into a moving picture having a low frame rate. In other words, after checking the vertical synchronization signal once, the controller 30 skips every other vertical synchronization signal having a frame frequency of 30 frames per second, and then adjusts the moving picture frames.

However, since the controller 30 skips every other vertical synchronization signal to adjust the number of moving picture frames, a large load is applied. A problem results in the moving picture where the number of frames adjusted is reproduced, and the moving picture screen is displayed with separation or distortion.

Accordingly, there is a need for an improved wireless terminal for displaying moving picture frames without separation or distortion.

### SUMMARY OF THE INVENTION

An aspect of embodiments of the present invention is to address at least the above problems and/or disadvantages and to provide at least the advantages described below. Accordingly, an aspect of embodiments of the present invention is to provide a wireless terminal capable of reducing distortion of a moving picture when the moving picture for transmission is reproduced.

In order to accomplish this objective, there is provided a wireless terminal. The wireless terminal includes a camera for shooting an image when the wireless terminal is set to a camera mode, and outputting data of the shot image in units of a frame. An image processor outputs video frames from the camera in a predetermined number per unit time, and generates and outputs a synchronization signal for the output video frames. A pulse generator generates a predetermined converted pulse in order to scale down a frame frequency of a vertical synchronization signal of the synchronization signal at a predetermined ratio. A converter generates and outputs a converted vertical synchronization signal where the frame frequency of the vertical synchronization signal is converted at a predetermined ratio according to combination of the vertical synchronization signal and the converted pulse. A controller adjusts the number of the video frames input from the image processor in a predetermined number per unit time according to the converted vertical synchronization signal, and controls the adjusted frames to be displayed on a display unit.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features and advantages of certain exemplary embodiments of the present invention will be more apparent from the following description taken in conjunction with the accompanying drawings, in which:

FIG. 1 is a block diagram showing a conventional wireless terminal;

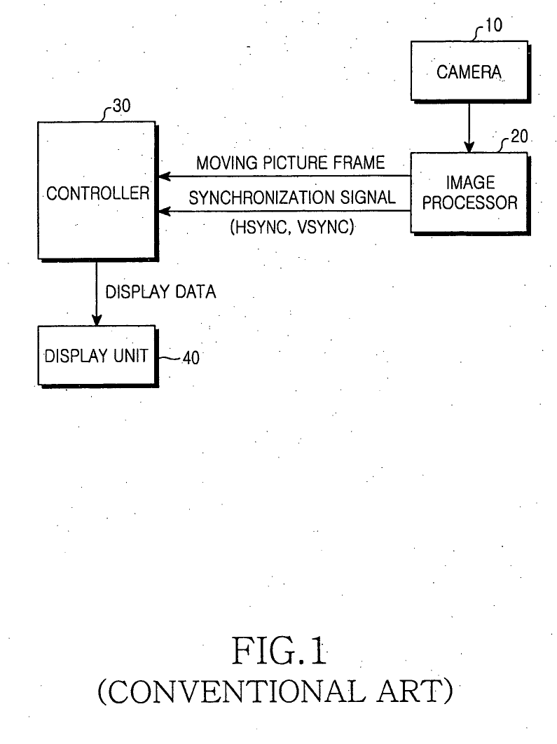

FIG. 2 is a block diagram showing a wireless terminal according to an exemplary embodiment of the present invention; and

FIGS. 3A, 3B and 3C are timing charts of the vertical synchronization signal, converted pulse, and converted vertical synchronization signal of a wireless terminal according to an exemplary embodiment of the present invention, respectively.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

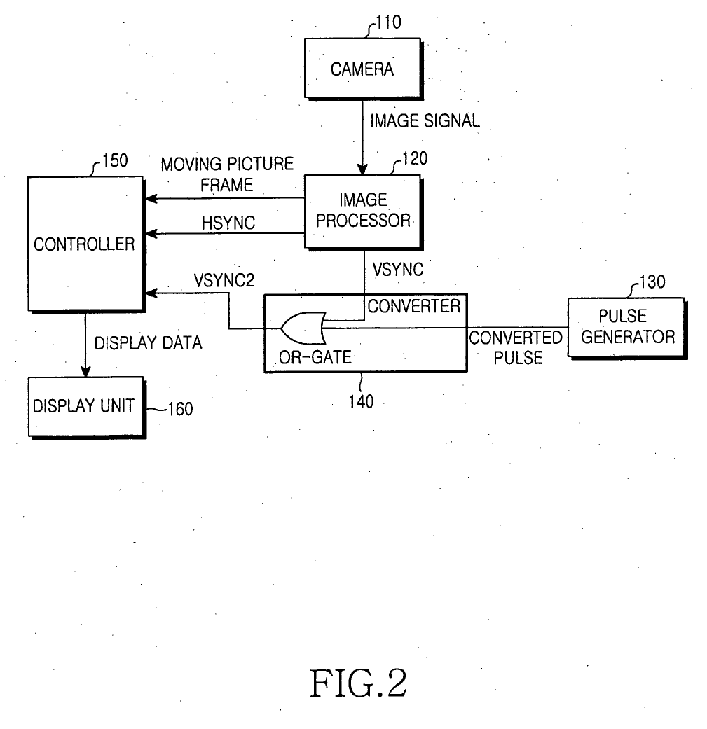

FIG. 2 is a block diagram showing a wireless terminal according to an exemplary embodiment of the present invention.

As shown, the wireless terminal includes a camera 110, an image processor 120, a pulse generator 130, a converter 140, a controller 150, and a display unit 160.

The camera 110 shoots an image when the wireless terminal is set to a camera mode, and delivers data of the shot image to the image processor 120 frame by frame. When the shot image is a still picture, one frame is delivered to the image processor 120. However, when the shot image is a moving picture, 30 frames per second are continuously delivered to the image processor 120.

The image processor 120 processes the image signal output from the camera 110 by the frame, and outputs the frame image data to meet a characteristic and size of the display unit 160. Further, the image processor 120 preferably has a video codec, which serves to compress the frame image data displayed on the display unit 160 in a preset mode, or restores the compressed frame image data into an original frame image data.

Further, the image processor 120 outputs video frames output from the camera 110 in a predetermined number (for example, 30) per unit time, generates a synchronization signal for the output video frames, and outputs the synchronization signal to the controller 150.

The synchronization signal is divided into two components: vertical synchronization signal VSYNC and horizontal synchronization signal HSYNC. For example, when 30 frames per unit time are output from the image processor 120, a frame frequency of the horizontal synchronization signal is 30 Hz. The vertical and horizontal synchronization signals are well-known. Therefore, detailed descriptions are omitted for clarity and conciseness.

The pulse generator 130 generates a predetermined converted pulse in order to scale down the frame frequency of the vertical synchronization signal of the synchronization signal at a predetermined ratio at the image processor 120. The vertical synchronization signal and the converted pulse have periods of N frame/s and M frame/s, respectively. The converted pulse is generated after being delayed by a predetermined time with respect to the vertical synchronization signal. For example, the vertical synchronization signal has a period of 30 frame/s (that is, a frame frequency of 30 Hz), and when to scaling down the frame frequency of the vertical synchronization signal from 30 Hz to 15 Hz, the converted pulse has a period of 15 frame/s. Thus, the converted pulse is generated after being delayed by a predetermined time (for example, 1/60 second) with respect to the vertical synchronization signal. In other words, when scaling down the frame frequency, a value of N is greater than a value of M at all times.

The pulse generator 130 may be included in the image processor 120. In this case, the image processor 120 can output the vertical synchronization signal and the converted pulse at the same time.

The converter 140 has a characteristic that, when any one of two input nodes is HIGH, the output node is HIGH. The converter 140 generates a converted vertical synchronization signal where the frame frequency of the vertical synchronization signal is converted at a predetermined ratio (for example, ½) according to a combination of the vertical synchronization signal and the converted pulse, and outputs the signal to the controller 150.

In FIG. 2, a construction of the converter 140 is illustrated as an OR gate that adopts the vertical synchronization signal and the converted pulse as inputs.

The controller 150 controls an overall operation of the wireless terminal according to an exemplary embodiment of the present invention. Further, the controller 150 adjusts the number of video frames input from the image processor 120 in a predetermined number per unit time according to the converted output vertical synchronization signal from the converter 140, and displays the adjusted frames on the display unit 160.

The controller 150 reads the moving picture of 15 frame/s from the image processor 120 when the frame frequency of the converted vertical synchronization signal is 15 Hz, and displays the moving picture on the display unit 160. Accordingly, in the moving picture output at a frame rate of 30 frame/s from the image processor 120, for example, only the odd-numbered frames are read and displayed on the display unit 160, whereas the even-numbered frames are deleted without being read.

According to an exemplary embodiment of the present invention as set forth above, the controller 150 directly skips the vertical synchronization signal, receives the compensated synchronization signal (that is, converted vertical synchronization signal) without a need to convert the moving picture from 30 frame/s to 15 frame/s, and reads only the moving picture of 15 frame/s out of the image processor 120. Therefore, the controller 150 can reduce distortion of a moving picture screen caused by a load when directly skipping the vertical synchronization signal.

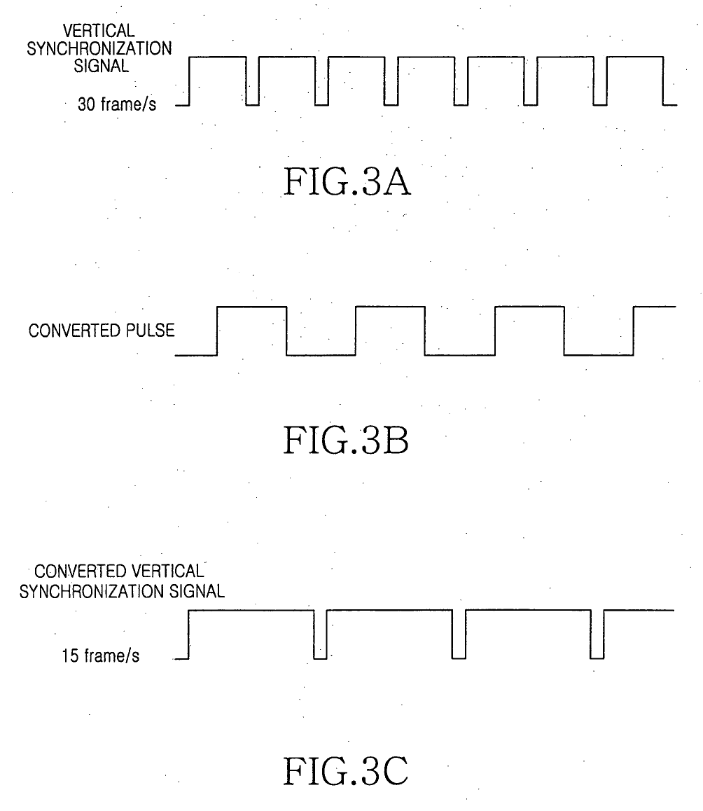

FIGS. 3A, 3B and 3C are timing charts of the vertical synchronization signal, converted pulse, and converted vertical synchronization signal of a wireless terminal, respectively, according to an exemplary embodiment of the present invention.

FIG. 3A is the timing chart of a vertical synchronization signal VSYNC having a frame frequency of 30 frame/sec. FIG. 3B is the timing chart of a converted pulse generated from the pulse generator 130 when the moving picture for transmission is shot. FIG. 3C is the timing chart of a converted vertical synchronization signal generated and output from the converter 140 that adopts the vertical synchronization signal and the converted pulse as inputs.

Referring to FIGS. 3A to 3C, when compensating for a vertical synchronization signal having a frame frequency of 30 Hz, that is a period of 30 frame/s as shown in FIG. 3A, into a converted vertical synchronization signal having a period of 15 frame/s, as shown in FIG. 3C, the pulse generator 130 generates a converted pulse, which has a period of 15 frame/s, as shown in FIG. 3B. The converted pulse is generated after being delayed by a predetermined time with respect to the vertical synchronization signal, and is output to the converter 140.

The converter 140, which is constructed as an OR gate in FIG. 2, has a characteristic that when any one of two input nodes is HIGH, the output node is HIGH.

Thus, the converter 140 receives the vertical synchronization signal of FIG. 3A and the converted pulse of FIG. 3B as inputs, and then outputs the converted vertical synchronization signal having the period of 15 frame/s.

As described from the foregoing exemplary embodiments, the controller of the wireless terminal reads the moving picture frames according to the compensated synchronization signal (that is, the converted vertical synchronization signal), and displays the frames on the display unit in order to reduce the distortion of the moving picture screen, which is caused by the load generated when the controller directly skips the vertical synchronization signal to adjust the number of moving picture frames.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A wireless terminal comprising:
a camera for shooting an image when the wireless terminal is set to a camera mode, and outputting the shot image data in units of a frame;
an image processor for outputting video frames from the camera in a predetermined number per unit time, and generating and outputting a synchronization signal for the output video frames;
a pulse generator for generating a predetermined converted pulse in order to scale down a frame frequency of a vertical synchronization signal of the synchronization signal at a predetermined ratio;
a converter for generating and outputting a converted vertical synchronization signal where the frame frequency of the vertical synchronization signal is converted at a predetermined ratio according to a combination of the vertical synchronization signal and the converted pulse; and
a controller for adjusting the number of video frames input from the image processor in a predetermined number per unit time according to the converted vertical synchronization signal, and controlling the adjusted frames to be displayed on a display unit.

2. The wireless terminal according to claim 1, wherein the image data is a moving picture data.

3. The wireless terminal according to claim 1, wherein the image processor includes a pulse generator.

4. The wireless terminal according to claim 1, wherein the vertical synchronization signal and the converted pulse have periods of N frame/s and M frame/s, respectively, and the converted pulse is generated after being delayed by a predetermined amount of time with respect to the vertical synchronization signal.

5. The wireless terminal according to claim 4, wherein the period of N frame/s has a value greater than the period of M frame/s.

6. The wireless terminal according to claim 5, wherein the value of N is 30, and the value of M is 15.

7. The wireless terminal according to claim 1, wherein the converter is constructed as an OR gate for adopting the vertical synchronization signal and converted pulse as inputs.

8. The wireless terminal according to claim 1, wherein the converted vertical synchronization signal has a period of frames which is twice as long as the vertical synchronization signal.

9. A method for reducing distortion of a moving picture screen in a wireless terminal, the method comprising:
shooting an image when the wireless terminal is set to a camera mode;
outputting video frames in a predetermined number per unit time, and generating and outputting a synchronization signal for the output video frames;
generating a predetermined converted pulse in order to scale down a frame frequency of a vertical synchronization signal of the synchronization signal at a predetermined ratio;
generating and outputting a converted vertical synchronization signal where frame frequency of the vertical synchronization signal is converted at a predetermined ratio according to a combination of the vertical synchronization signal and the converted pulse; and
adjusting the number of video frames input from the image processor in a predetermined number per unit time according to the converted vertical synchronization signal, and controlling the adjusted frames to be displayed on a display unit.

10. The method of claim 1, wherein the image data is a moving picture data.

11. The method of claim 1, wherein the vertical synchronization signal and the converted pulse have periods of N frame/s and M frame/s, respectively, and the converted pulse is generated after being delayed by a predetermined amount of time with respect to the vertical synchronization signal.

12. The method of claim 11, wherein the period of N frame/s has a value greater than the period of the M frame/s.

13. The method of claim 12, wherein the value of N is 30, and the value of M is 15.

14. The method of claim 1, wherein the converted vertical synchronization signal has a period of frames which is twice as long as the vertical synchronization signal.
